(19) United States
(12) Patent Application Publication
(10) Pub. No.: US 2012/0010798 A1
(43) Pub. Date: Jan. 12, 2012

(54) CONTROL DEVICE AND CONTROL METHOD FOR FOUR-WHEEL DRIVE VEHICLE

(75) Inventor: Kohei Ito, Okazaki-shi (JP)

(73) Assignee: TOYOTA JIDOSHA KABUSHIKI KAISHA, Toyota-shi (JP)

(21) Appl. No.: 13/178,934

(22) Filed: Jul. 8, 2011

(30) Foreign Application Priority Data
Jul. 9, 2010 (JP) 2010-157193

(51) Int. Cl. G06F 19/00

(52) U.S. Cl. 701/70

(57) ABSTRACT

In a control for a four-wheel drive vehicle that is able to travel in a non-differential mode in which differential rotation between front wheels and rear wheels is limited, it is determined whether a drive train is placed in a twisted state where a twisting torque resulting from a twist accumulated in the drive train is larger than or equal to a predetermined torque while the vehicle is cornering in the non-differential mode, and braking force is applied to the front wheels by a wheel brake device when it is determined that the drive train is placed in the twisted state.

### INCORPORATION BY REFERENCE

This application claims priority of Japanese Patent Application No. 2010-157193 filed on Jul. 9, 2010, which is incorporated herein by reference in its entirety including the specification, drawings and abstract.

### BACKGROUND OF THE INVENTION

1. Field of the Invention

The invention relates to a control device and control method for a four-wheel drive vehicle that is able to travel in a non-differential mode of front and rear wheels.

2. Description of Related Art

There is widely known a four-wheel drive vehicle that is able to travel in a non-differential mode in which differential rotation between front wheels and rear wheels is limited. For example, Japanese Patent Application Publication No. 2008-143380 (JP-A-2008-143380) and Japanese Patent Application Publication No. 2000-344077 (JP-A-2000-344077) describe such a vehicle. For example, JP-A-2008-143380 describes that, in a full-time four-wheel drive vehicle in which the power of an engine is distributed between a front wheel-side propeller shaft and a rear wheel-side propeller shaft via a center differential (hereinafter, referred to as center diff), when the center diff is changed from a free mode to a diff locked mode, differential action is limited so that the average rotational speed of the front wheels is equal to the average rotational speed of the rear wheels. In addition, JP-A-2008-143380 describes that a part-time four-wheel drive vehicle, of which a center diff is replaced with a lock mechanism, normally travels in a two-wheel drive mode and, where necessary, travels in a directly-coupled four-wheel drive mode in which front and rear propeller shafts are directly coupled to each other. The directly-coupled four-wheel drive mode is equivalent to the center diff locked mode of the full-time four-wheel drive vehicle.

Incidentally, when a vehicle turns a corner, there occurs a difference in rotation between front wheels and rear wheels because of a difference in turning radius between front and rear wheels. At this time, when a four-wheel drive vehicle turns a corner in a non-differential mode, a twisting torque due to a twist occurs in a drive train. That is, when the drive train is connected via a travelling road surface, and when there is a difference in rotation between the front and rear wheels, a twist accumulates somewhere in the drive train, and then a circulating torque occurs. For example, when the four-wheel drive vehicle turns a corner, the average rotational speed of the front wheels is higher than the average rotational speed of the rear wheels, so, in the case of the non-differential mode, a negative torque (decelerating torque) that causes the wheels to rotate acts from the travelling road to the front wheels and a positive torque acts on the rear wheels. That is, front wheel-side drive shafts (hereinafter, front DSs) that constitute part of the drive train are twisted by the wheels in a vehicle travel rotation direction, and a decelerating torque is applied to the front DSs although a driving force source causes the front DSs to generate a drive torque. The thus generated twisting torque continues to increase as far as the four-wheel drive vehicle is set in the non-differential mode until at least any one of the four wheels slips. A torque at which at least one of the wheels starts to slip (hereinafter, referred to as tractive torque) is relatively large, so the durability of portions that constitute the drive train may possibly deteriorate. Particularly, when the weight of a vehicle is relatively heavy or when the vehicle total weight is relatively heavy, a tractive torque increases (that is, the wheels are hard to start slipping), so a larger twisting torque accumulates and, as a result, the durability of the portions of the drive train may possibly further deteriorate. In addition, when the vehicle is cornering, wheel-side joints of the front DSs are turned at a large angle, and the durability of the front DSs may considerably deteriorate as compared with when the vehicle is travelling straight ahead. The above problems are not in a public domain, and, for example, executing braking force control in terms of protecting portions of a drive train has not been suggested yet.

### SUMMARY OF THE INVENTION

The invention provides a control device and control method for a four-wheel drive vehicle, which are able to improve the durability of components of a drive train by reducing a twisting torque applied to the drive train.

A first aspect of the invention relates to a control device for a four-wheel drive vehicle that is able to travel in a non-differential mode in which differential rotation between front wheels and rear wheels is limited. The control device includes: a control condition determination unit that determines whether a drive train is placed in a twisted state where a twisting torque resulting from a twist accumulated in the drive train is larger than or equal to a predetermined torque while the vehicle is cornering in the non-differential mode; and a braking force control unit that applies braking force to the front wheels by a wheel brake device when it is determined that the drive train is placed in the twisted state.

By so doing, when the drive train is placed in the twisted state where the twisting torque resulting from the twist accumulated in the drive train is larger than or equal to the predetermined torque during cornering in the non-differential mode, braking force is applied to the front wheels by the wheel brake device. Therefore, for example, part of a negative torque (decelerating torque) that acts on the front wheels may be cancelled by the braking torque applied by the wheel brake device, so the twisting torque that is substantially applied to the drive train is reduced. That is, part of a generated twisting torque is cancelled by the braking torque, so the twisting torque that acts on the drive train components is reduced. Thus, the durability of the drive train components is improved. Therefore, for example, it is not necessary to increase the size of the drive train components in order to ensure the durability of the drive train components, and it is possible to reduce the size and weight of the drive train components.

In the control device, the predetermined torque may be reduced as a steering angle during the cornering increases. In addition, the predetermined torque may be an allowable value of the twisting torque for suppressing deterioration of durability of drive train components, and may be set on the basis of an actual steering angle from a predetermined correlation. By so doing, for example, in contrast to a decrease in allowable torque of the drive train components (for example, front DSs) against a twisting torque as the steering angle increases, the predetermined torque is set from the above correlation, so the twisting torque that acts on the drive train components is appropriately reduced to thereby improve the durability of the drive train components. In addition, braking torque is applied by the wheel brake device in accordance with a steering angle, so turning performance (travelling performance) is appropriately ensured. That is, for example, part of a decelerating torque that acts on the front wheels is appropriately cancelled by the braking torque applied by the wheel brake device, so a decelerating torque of the vehicle overall is not increased by the braking torque, and travelling performance is appropriately ensured.

In the control device, the twist may be accumulated in the drive train because of a front and rear wheel rotational speed difference between the front wheels and the rear wheels, and it may be determined whether the drive train is placed in the twisted state on the basis of the front and rear wheel rotational speed difference. By so doing, for example, it may be appropriately determined whether the drive train is placed in the twisted state where the twisting torque is larger than or equal to the predetermined torque.

In the control device, an amount of twist accumulated in the drive train may be calculated on the basis of an integrated value of the front and rear wheel rotational speed difference during the cornering, a predetermined amount of twist may be set on the basis of the predetermined torque from a predetermined correlation in which the twisting torque increases as the amount of twist increases, and, when the amount of twist is larger than or equal to the predetermined amount of twist, it may be determined that the drive train is placed in the twisted state. By so doing, for example, it may be appropriately determined that the drive train is placed in the twisted state where the twisting torque is larger than or equal to the predetermined torque.

In the control device, the braking force control unit may apply braking force to the front wheels so as to cancel a difference between the twisting torque and the predetermined torque when it is determined that the drive train is placed in the twisted state. By so doing, for example, part of the generated twisting torque may be appropriately cancelled by the braking torque applied by the wheel brake device so that the twisting torque that acts on the drive train components is not larger than or equal to the predetermined torque.

A second aspect of the invention relates to a control method for a four-wheel drive vehicle that is able to travel in a non-differential mode in which differential rotation between front wheels and rear wheels is limited. The control method includes: determining whether a drive train is placed in a twisted state where a twisting torque resulting from a twist accumulated in the drive train is larger than or equal to a predetermined torque while the vehicle is cornering in the non-differential mode; and applying braking force to the front wheels by a wheel brake device when it is determined that the drive train is placed in the twisted state.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram that illustrates the configuration of a vehicle according to an embodiment of the invention, and is a block diagram that illustrates a relevant portion of a control system provided for the vehicle;

FIG. 2 is a skeleton diagram of a transfer of a vehicle power transmission device of FIG. 1;

FIG. 3 is a diagram for illustrating a twisting torque that occurs when the vehicle is cornering in a center diff locked mode;

FIG. 4 is a functional block diagram that illustrates a relevant portion of control functions implemented by an electronic control unit shown in FIG. 1;

FIG. 5 is a graph that shows an example of a correlation (allowable torque map) in which a DS allowable torque reduces as a steering angle of a steering wheel increases according to the embodiment of the invention;

FIG. 6 is a graph that shows an example of a correlation (twisting torque map) in which a DS twisting torque increases as a DS twisted amount increases according to the embodiment of the invention;

FIG. 7 is a graph that shows an example of a correlation (required brake torque map) in which a required front brake torque increases as a DS twisted amount difference increases according to the embodiment of the invention;

FIG. 8 is a flowchart that illustrates a relevant portion of control operations of the electronic control unit shown in FIG. 1, that is, control operations for improving the durability of drive train components by reducing a twisting torque substantially applied to a drive train; and

FIG. 9 is a diagram that illustrates a part-time four-wheel drive vehicle, which is different from a full-time four-wheel drive vehicle, according to another embodiment of the invention.

### DETAILED DESCRIPTION OF EMBODIMENTS

In an embodiment of the invention, a four-wheel drive vehicle is, for example, a so-called full-time four-wheel drive vehicle in which power of a driving force source is distributed between a front wheel-side power transmission path and a rear wheel-side power transmission path via a center differential (center diff) that is alternatively changeable between a free mode and a locked mode. When the center diff is changed from the free mode to the locked mode (center diff locked mode), the four-wheel drive vehicle is able to travel in a non-differential mode where differential rotation between front wheels and rear wheels is limited.

In addition, the four-wheel drive vehicle may be, for example, a so-called part-time four-wheel drive vehicle in which the center diff is replaced with a lock mechanism, instead of the full-time four-wheel drive vehicle. The four-wheel drive vehicle travels in a two-wheel drive mode when the lock mechanism is set in the free mode; whereas, when the lock mechanism is set in the locked mode, the front and rear power transmission paths are directly coupled to each other to enter a direct-coupling four-wheel drive mode, and, as in the case of the center diff locked mode of the full-time four-wheel drive vehicle, the four-wheel drive vehicle is able to travel in a non-differential mode where differential rotation between the front wheels and the rear wheels is limited.

In addition, the four-wheel drive vehicle may include a vehicle power transmission device in a power transmission path from the driving force source to the wheels. The driving force source may be desirably, for example, an internal combustion engine, or the like, that generates power through combustion of fuel, such as a gasoline engine and a diesel engine, and may be another prime mover, such as an electric motor, alone or may be a prime mover and an engine in combination.

In addition, the vehicle power transmission device may be formed of a transmission alone, may be formed of a torque converter and a transmission having a plurality of speed ratios, or may be formed of a transfer, a speed reduction mechanism portion or a differential mechanism portion in addition to the transmission, and the like. The transmission is formed of various types of planetary gear automatic transmission, a synchromesh parallel two shaft transmission, a synchromesh parallel two shaft automatic transmission, a so-called dual clutch transmission (DCT), a so-called belt-type continuously variable transmission, a so-called traction-type continuously variable transmission, or the like. The various types of planetary gear automatic transmission have, for example, forward four speeds, forward five speeds, forward six speeds or more speeds, in which a plurality of gears (speeds) are alternatively achieved in such a manner that rotating elements of a plurality of sets of planetary gear units are selectively coupled by engaging devices. The synchromesh two parallel shaft transmission includes a plurality of pairs of continuously engaged transmission gears between the two shafts and uses a synchronizer to alternatively place any one of those plurality of pairs of transmission gears in a power transmission state. The synchromesh two parallel shaft automatic transmission, which is one of the synchromesh two parallel shaft transmissions, is able to automatically shift speeds by a synchronizer driven by a hydraulic actuator. The dual clutch transmission (DCT), which is one of the synchromesh two parallel shaft automatic transmissions, includes two lines of input shafts, which are respectively connected to corresponding clutches and are respectively connected to even-numbered gears and odd-numbered gears. The belt-type continuously variable transmission is configured so that a transmission belt that functions as a power transmission member is wound around a pair of variable pulleys of which the effective diameter is variable and then the speed ratio is steplessly varied. The traction-type continuously variable transmission includes a pair of cones rotated around a common axis and a plurality of rollers that are rotatable around a rotation center that intersects with the axis and that are held between the pair of cones, and is able to vary the speed ratio in such a manner that the intersection angle between the rotation center of each roller and the axis is varied.

Hereinafter, an embodiment of the invention will be described in detail with reference to the accompanying drawings.

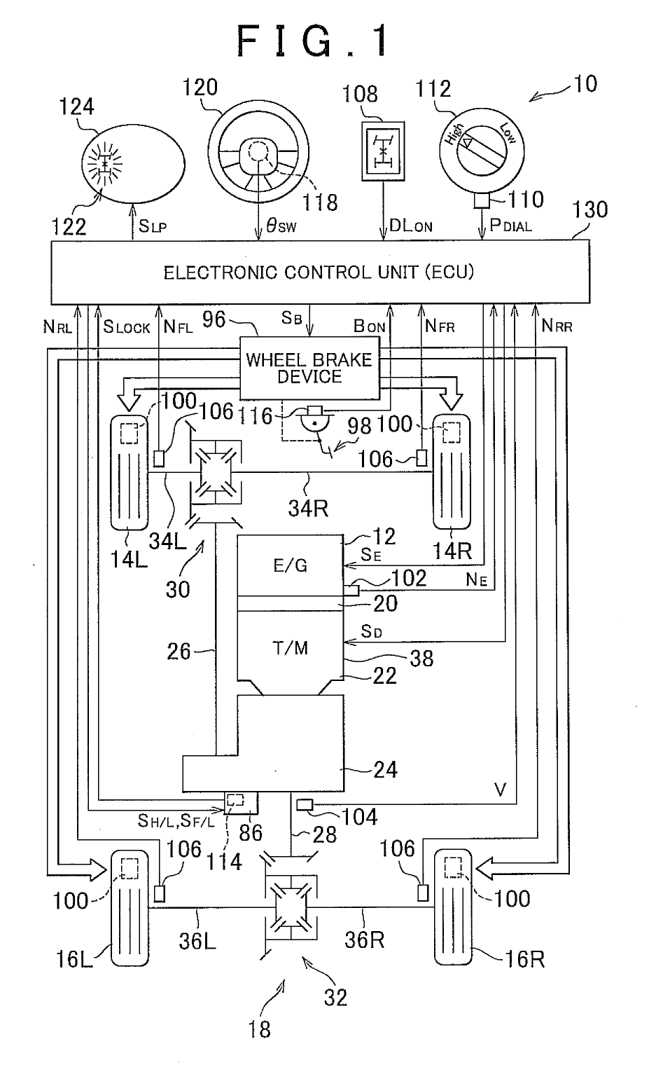

FIG. 1 is a diagram that illustrates the configuration of a vehicle 10 according to the embodiment of the invention, and is a block diagram that illustrates a relevant portion of a control system provided for the vehicle 10. As shown in FIG. 1, the vehicle 10 is, for example, a so-called full-time four-wheel drive vehicle that is able to constantly travel in an all-wheel drive mode (four-wheel drive mode). The vehicle 10 includes a vehicle power transmission device 18. The vehicle power transmission device 18 transmits power from an engine 12, which serves as a driving force source for propelling the vehicle 10, to each of a pair of right and left front wheels 14R and 14L (front wheels 14 when the right and left front wheels are not particularly distinguished from each other) and a pair of right and left rear wheels 16R and 16L (rear wheels 16 when the right and left rear wheels are not particularly distinguished from each other). The vehicle power transmission device 18 includes an automatic transmission 22, a transfer (power distribution device) 24, a front propeller shaft 26, a rear propeller shaft 28, a front wheel differential gear unit 30, a rear wheel differential gear unit 32, a pair of right and left front wheel drive shafts 34R and 34L (front drive shafts (front DSs 34) when the right and left front wheel drive shafts are not distinguished from each other) and a pair of right and left rear wheel drive shafts 36R and 36L (rear drive shafts (rear DSs 36) when the right and left rear wheel drive shafts are not distinguished from each other). The automatic transmission 22 has a torque converter 20 that is coupled to the engine 12. The transfer 24 is coupled to the output side of the automatic transmission 22, and distributes power transmitted from the automatic transmission 22 between a side adjacent to the front wheels 14 and a side adjacent to the rear wheels 16. The front propeller shaft 26 transmits the power distributed by the transfer 24 to the side adjacent to the front wheels 14. The rear propeller shaft 28 transmits the power distributed by the transfer 24 to the side adjacent to the rear wheels 16. The front wheel differential gear unit 30 is coupled to the front propeller shaft 26. The rear wheel differential gear unit 32 is coupled to the rear propeller shaft 28. The pair of right and left front wheel drive shafts 34R and 34L transmit the power distributed via the front wheel differential gear unit 30 to the front wheels 14. The pair of right and left rear wheel drive shafts 36R and 36L transmit the power distributed via the rear wheel differential gear unit 32 to the rear wheels 16. In the thus configured vehicle power transmission device 18, power generated by the engine 12 is transmitted to the pair of front wheels 14 and the pair of rear wheels 16 via a power transmission path that is formed of the torque converter 20, the automatic transmission 22, the transfer 24, the front propeller shaft 26 and the rear propeller shaft 28, the front wheel differential gear unit 30 and the rear wheel differential gear unit 32, the pair of right and left front DSs 34 and the pair of right and left rear DSs 36, and the like, sequentially.

The engine 12 is, for example, an internal combustion engine, such as a gasoline engine and a diesel engine, that generates driving force through combustion of fuel injected into a cylinder. In addition, the torque converter 20 is a hydraulic power transmission device. The torque converter 20, for example, includes a pump impeller, a turbine impeller and a stator impeller. The pump impeller is coupled to a crankshaft of the engine 12. The turbine impeller is coupled to an input shaft of the automatic transmission 22. The stator impeller is fixed to a transmission case 38 via a one-way clutch. The torque converter 20 transmits power between the pump impeller and the turbine impeller via fluid. In addition, the automatic transmission 22, for example, includes a plurality of frictional engagement elements. The automatic transmission 22 selectively establishes a plurality of speed ratios in correspondence with combinations of engagement or release of those frictional engagement elements to thereby shift driving force input from the input shaft and then output the shifted driving force.

The transfer 24, for example, selectively changes between a differential mode where differential rotation between the rear propeller shaft 28 and the front propeller shaft 26 is not limited and a non-differential mode where differential rotation therebetween is limited, and distributes power from the automatic transmission 22 between the front wheels 14 and the rear wheels 16. In addition, the transfer 24 also functions as an auxiliary transmission. The transfer 24, for example, selectively establishes any one of a high gear (high speed) H and a low gear (low speed) L to shift power from the automatic transmission 22 and then transmits the shifted power to the downstream component.

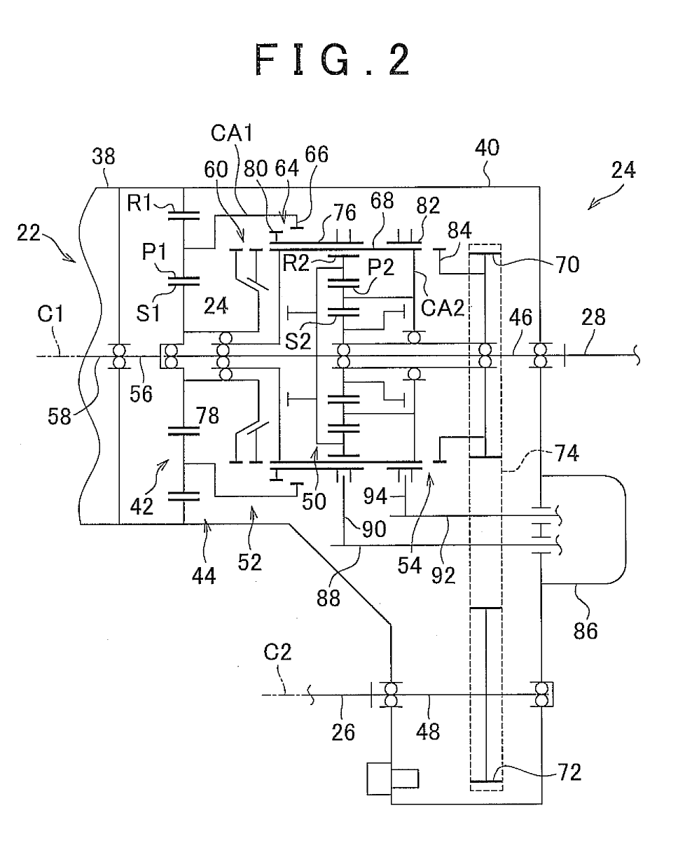

FIG. 2 is a skeleton diagram of the transfer 24. Note that FIG. 2 is a development diagram that shows respective axes of an input shaft 56, a first output shaft 46, a second output shaft 48, a first shift fork shaft 88 and a second shift fork shaft 92 (which will be described later) in the same plane. In FIG. 2, the transfer 24 includes a transfer case 40 that is coupled to a vehicle rear side of the transmission case 38 of the automatic transmission 22. The transfer case 40 serves as a non-rotating member. In addition, the transfer 24 includes an auxiliary transmission 44, a center diff (center differential unit) 50, a dog clutch device 52 and a diff lock device 54 along a common axis C1 in the transfer case 40. The auxiliary transmission 44 is principally formed of a single pinion-type planetary gear unit 42. The center diff 50 distributes power (torque) between the first output shaft 46 and the second output shaft 48 while allowing a difference in rotation therebetween. The first output shaft 46 is supported by the transfer case 40 so as to be rotatable around the axis C1, and is coupled to the rear propeller shaft 28. The second output shaft 48 is supported by the transfer case 40 so as to be rotatable around an axis C2, and is coupled to the front propeller shaft 26. The dog clutch device 52 alternatively establishes a low gear L or a high gear H in such a manner that any one of two power transmission paths from the auxiliary transmission 44 to the center diff 50 is coupled. The diff lock device 54 is used to limit operations for allowing the difference in rotation in the center diff 50, that is, limit differential rotation between the first output shaft 46 and the second output shaft 48 to enter a center diff locked mode. The transfer 24 shifts the rotation of the input shaft 56 that is supported by the transfer case 40 so as to be rotatable around the axis C1, and then outputs the shifted rotation from the first output shaft 46 and the second output shaft 48 in the differential mode or in a direct-coupling mode. The input shaft 56 is coupled to an output shaft 58 of the automatic transmission 22 by spline-fitting coupling, or the like. The input shaft 56 is driven for rotation by power (torque) input from the engine 12 via the automatic transmission 22.

The planetary gear unit 42 includes a first sun gear S1, a ring gear R1 and a carrier CA1. The first sun gear S1 is coupled to the outer peripheral surface of the input shaft 56 so as to be non-rotatable around the axis C1 with respect to the outer peripheral surface of the input shaft 56. The ring gear R1 is arranged substantially concentrically with respect to the first sun gear S1, and is coupled to the transfer case 40 so as to be non-rotatable around the axis C1. The carrier CA1 supports a plurality of pinion gears P1 that are in mesh with these sun gear S1 and ring gear R1 so as to be rotatable and revolvable around the sun gear S1. Thus, the rotational speed of the sun gear S1 is equal to the rotational speed of the input shaft 56, and the rotational speed of the carrier CA1 is decreased with respect to the rotational speed of the input shaft 56. In addition, a clutch gear 62 that serves as a synchronized member of a synchromesh mechanism 60 relevant to establishment of the high gear H within the dog clutch device 52 is fixed to the sun gear S1 so as to be non-rotatable around the axis C1 with respect to the sun gear S1. In addition, a clutch gear 66 that serves as a synchronized member of a dog clutch 64 relevant to establishment of the low gear L within the dog clutch device 52 is fixed to the carrier CA1 so as to be non-rotatable around the axis C1 with respect to the carrier CA1.

The center diff 50 is a widely known so-called torque-sensing limited slip differential. The center diff 50 includes a differential case 68, a ring gear R2, a sun gear S2 and a carrier CA2. The differential case 68 is supported by the first output shaft 46 so as to be rotatable around the axis C1. The ring gear R2 is coupled to the first output shaft 46 so as to be relatively non-rotatable around the axis C1 inside the differential case 68. The sun gear S2 is arranged substantially concentrically with respect to the ring gear R2, and is supported by the outer peripheral portion of the first output shaft 46 so as to be relatively rotatable around the axis C1 with respect to the first output shaft 46. The carrier CA2 supports a plurality of pinion gears P2 that are in mesh with these sun gear S2 and ring gear R2 so as to be rotatable and revolvable around the sun gear S2, and is coupled to the differential case 68. The sun gear S2 is coupled to a drive gear 70. The drive gear 70 is supported by the first output shaft 46 so as to be rotatable around the axis C1 with respect to the first output shaft 46, as in the case of the sun gear S2. The rotation of the drive gear 70 is transmitted to a driven gear 72 via a chain 74. The driven gear 72 is coupled to the second output shaft 48 so as to be non-rotatable around the second output shaft 48. The chain 74 is wound around those drive gear 70 and driven gear 72. In the thus configured center diff 50, when the vehicle 10 travels straight ahead, the torque transmitted from the planetary gear unit 42 to the differential case 68 is transmitted to the first output shaft 46 and the second output shaft 48 via the ring gear R2 and the sun gear S2. In addition, when the vehicle 10 turns a corner, part of the torque input from the differential case 68 to the sun gear S2 is transmitted to the ring gear R2 via the carrier CA2 and the differential case 68, and is then transmitted to the first output shaft 46 and the second output shaft 48 at a distribution of torque that is larger to the rear side than to the front side as compared with a distribution of torque when the vehicle 10 travels straight ahead.

The dog clutch device 52 includes the synchromesh mechanism 60 and the dog clutch 64. The synchromesh mechanism 60 is used to establish the high gear H. The dog clutch 64 is used to establish the low gear L. The synchromesh mechanism 60 is a widely known so-called synchronization mechanism. The synchromesh mechanism 60 has a cylindrical sleeve 76, the clutch gear 62 and a synchronizer ring (synchronous ring) 78. The sleeve 76 is, for example, spline-fitted to the differential case 68 so as to be relatively non-rotatable around the axis C1 and relatively movable in a direction along the axis C1. The clutch gear 62 has outer peripheral teeth that mesh with inner peripheral teeth of the inner peripheral surface of the sleeve 76 so as to be relatively non-rotatable around the axis C1 and relatively movable in the direction along the axis C1. The clutch gear 62 is arranged between the planetary gear unit 42 and the differential case 68, and is fixed to the sun gear S1. The synchronizer ring inhibits movement of the sleeve 76 toward the clutch gear 62 when the rotation of the sleeve 76 and the rotation of the clutch gear 62 are in an asynchronous state. In the present embodiment, the sleeve 76 functions as a shift ring that is moved in the direction along the axis C1 by a shift actuator 86 (described later). In addition, the dog clutch 64 has the sleeve 76 and the clutch gear 66. The sleeve 76 serves as the shift ring. The clutch gear 66 has inner peripheral teeth that mesh with outer peripheral teeth 80 provided at the outer peripheral portion of the sleeve 76 so as to be relatively non-rotatable around the axis C1 and relatively movable in the direction along the axis C1. The clutch gear 66 is arranged on the opposite side of outer peripheral teeth 80 with respect to the clutch gear 62, and is fixed to the carrier CA1. In the thus configured dog clutch device 52, the sleeve 76 slides in the direction along the axis C1 to mesh with the clutch gear 62 while meshing with the differential case 68 to thereby establish the high gear H, and the sleeve 76 slides in the direction along the axis C1 to mesh with the clutch gear 66 while meshing with the differential case 68 to thereby establish the low gear L. At this time, the path along which power is transmitted to the differential case 68 via the carrier CA1 and the clutch gear 66 functions as a power transmission path that establishes the low gear L, and the path along which power is transmitted to the differential case 68 via the sun gear 51 and the clutch gear 62 functions as a power transmission path that establishes the high gear H. Note that, in the present embodiment, the differential case 68 functions as a clutch hub of the synchromesh mechanism 60. In addition, the dog clutch device 52 is operated for engagement in order to shift the auxiliary transmission 44.

The diff lock device 54 has a cylindrical sleeve 82 and a clutch gear 84. The sleeve 82 is, for example, spline-fitted to the differential case 68 so as to be relatively non-rotatable around the axis C1 and relatively movable in the direction along the axis C1. The clutch gear 84 has outer peripheral teeth that mesh with inner peripheral teeth of the inner peripheral surface of the sleeve 82 so as to be relatively non-rotatable around the axis C1 and relatively movable in the direction along the axis C1. The clutch gear 84 is arranged between the drive gear 70 and the differential case 68, and is fixed to the drive gear 70. In the thus configured diff lock device 54, the sleeve 82 slides in the direction along the axis C1 to mesh with the clutch gear 84 while meshing with the differential case 68. By so doing, the diff lock device 54 limits differential action of the center diff 50 to enter the center diff locked mode. Note that, in the present embodiment, the differential case 68 functions as a clutch hub of the diff lock device 54.

Here, the dog clutch device 52 and the diff lock device 54 are operated for engagement by the shift actuator 86 that is driven by an electronic control unit 130 (see FIG. 1). That is, the dog clutch device 52 is configured so that the first shift fork shaft 88 is actuated in a direction parallel to the axis C1 by driving the shift actuator 86 to actuate the sleeve 76 in the direction along the axis C1 via a first shift fork 90. The first shift fork shaft 88 corresponds to an output member of the shift actuator 86, and projects in the direction parallel to the axis C1. The first shift fork 90 is fixed to the first shift fork shaft 88 so as to be engageable with the sleeve 76 in the direction along the axis C1 and relatively rotatable around the axis C1 with respect to the sleeve 76. In addition, the diff lock device 54 is configured so that the second shift fork shaft 92 is actuated in the direction parallel to the axis C1 by driving the shift actuator 86 to actuate the sleeve 82 in the direction along the axis C1 via a second shift fork 94. The second shift fork shaft 92 functions as an output member of the shift actuator 86, and projects in the direction parallel to the axis C1. The second shift fork 94 is fixed to the second shift fork shaft 92 so as to be engageable with the sleeve 82 in the direction along the axis C1 and relatively rotatable around the axis C1 with respect to the sleeve 82.

In this way, the vehicle 10 is a full-time four-wheel drive vehicle that is able to constantly travel in a four-wheel drive mode in which power from the engine 12 is transmitted to the rear wheels 16 and the front wheels 14 via the transfer 24. Furthermore, the vehicle 10 is a four-wheel drive vehicle that is able to travel in the non-differential mode (locked mode) in which differential rotation between the front wheels 14 and the rear wheels 16 is limited in such a manner that the diff lock device 54 is operated for engagement by the shift actuator 86.

Referring back to FIG. 1, a wheel brake device 96 brakes the wheels (the front wheels 14 and the rear wheels 16), and is, for example, a disk brake or a drum brake. Specifically, the wheel brake device 96 is a foot brake device that supplies braking hydraulic pressure to wheel cylinders 100 provided respectively for the wheels (the front wheels 14 and the rear wheels 16) in response to operation of a brake pedal 98, or the like, to apply a wheel brake torque (hereinafter, referred to as brake torque T_{B}), corresponding to braking force, to the wheels. In the wheel brake device 96, normally, a braking hydraulic pressure corresponding to force on the brake pedal 98 generated in a master cylinder (not shown) is directly supplied to each wheel cylinder 100. On the other hand, for example, during braking force control at the time of cornering, during ABS control or during hill hold control, in order to generate a brake torque T_{B} at the time of cornering, to brake the vehicle on a low μ road or to hold or maintain stop of the vehicle halfway on a slope road, a braking hydraulic pressure that does not correspond to force on the brake pedal 98 is controlled for each wheel and is supplied to each wheel cylinder 100.

In addition, as shown in FIG. 1, the vehicle 10 is, for example, equipped with the electronic control unit 130 that includes a controller for the four-wheel drive vehicle that is able to travel in the non-differential mode in which differential rotation between the front wheels 14 and the rear wheels 16 is limited. The electronic control unit 130 is formed to include a so-called microcomputer that, for example, includes a CPU, a RAM, a ROM, an input/output interface, and the like. The CPU utilizes the temporary storage function of the RAM and executes signal processing in accordance with programs prestored in the ROM to thereby execute output control over the engine 12, shift control over the automatic transmission 22, engagement control over the dog clutch device 52 or the diff lock device 54 in the transfer 24, braking force control using the wheel brake device 96, and the like.

The electronic control unit 130 is, for example, supplied with a signal that indicates an engine rotational speed N_{E}, a signal that indicates a vehicle speed V, signals that respectively indicate wheel speeds N_{FR}, N_{FL}, N_{RR} and N_{RL}, a diff lock operation signal DL_{ON}, a signal that indicates an operating position P_{DIAL} of a speed shift dial switch 112, a diff lock signal S_{LOCK}, a brake operation signal B_{ON}, signals that respectively indicate a steering angle θ_{SW} and steering direction of a steering wheel 120. The engine rotational speed N_{E} is detected by an engine rotational speed sensor 102. The vehicle speed V corresponds to an output rotational speed N_{RP} of the rear propeller shaft 28, detected by a rear propeller shaft rotational speed sensor 104. The wheel speeds N_{FR}, N_{FL}, N_{RR} and N_{RL} correspond to rotational speeds N_{W} of the respective wheels (that is, the front wheels 14R and 14L and the rear wheels 16R and 16L) detected by respective wheel speed sensors 106. The diff lock operation signal DL_{ON} indicates that a center diff lock switch 108 is turned on, which is detected by the center diff lock switch 108 and which indicates a command to change into the center diff locked mode. The operating position P_{DIAL} of the speed shift dial switch 112 is detected by a dial position sensor 110. The diff lock signal S_{LOCK} indicates the locked mode of the center diff 50, which is detected by a diff lock detecting switch 114 provided for the shift actuator 86 and which indicates that the diff lock device 54 has completed changing into an engaged state. The brake operation signal B_{ON} indicates that the brake pedal 98 is operated, which is detected by a foot brake switch 116 and which indicates that the wheel brake device 96 is actuated. The steering angle θ_{SW} and steering direction of the steering wheel 120 are detected by a steering sensor 118.

In addition, the electronic control unit 130, for example, outputs an engine output control command signal S_{E}, a shift control command signal S_{T}, a high/low shift control command signal S_{H/L}, a center diff mode change control command signal S_{F/L}, a lamp control command signal S_{LP}, a wheel brake operation signal S_{B}, and the like. The engine output control command signal S_{E} is used for output control over the engine 12. The shift control command signal S_{T} is used for shift control over the automatic transmission 22. The high/low shift control command signal S_{H/L}, is used to actuate the dog clutch device 52 via the first shift fork shaft 88 by the shift actuator 86 to thereby shift the gear of the auxiliary transmission 44 into the high gear H or the low gear L. The center diff mode change control command signal S_{F/L}, is used to actuate the diff lock device 54 via the second shift fork shaft 92 by the shift actuator 86 to thereby change the center diff 50 into the free mode or locked mode. The lamp control command signal S_{LP} is used to control on/off of a diff lock indicator lamp 122. The wheel brake operation signal S_{B} is used to actuate the wheel brake device 96.

The speed shift dial switch 112 is, for example, a dial switch that is provided near a driver seat and is manually operated by a user. The speed shift dial switch 112 has two operating positions P_{DIAL}, for issuing a command to shift into any one of the high gear H and the low gear L. For example, when the speed shift dial switch 112 is operated to High position, the operating position signal P_{DIAL}, that indicates the High position is output, and then the electronic control unit 130 executes engagement control over the dog clutch device 52 to thereby shift the auxiliary transmission 44 into the high gear H. On the other hand, for example, when the speed shift dial switch 112 is operated to Low position, the operating position signal P_{DIAL}, that indicates the Low position is output, and then the electronic control unit 130 executes engagement control over the dog clutch device 52 to thereby shift the auxiliary transmission 44 into the low gear L. Note that the speed shift dial switch 112 is not limited to the above dial type; instead, the speed shift dial switch 112 may be, for example, a slide type, a seesaw type, a push button type, or the like.

In addition, the center diff lock switch 108 is, for example, a push button switch, with a latch, that is provided near the driver seat side by side with the speed shift dial switch 112 and that is manually operated by the user. The center diff lock switch 108 is used to select any one of the differential mode (free mode, diff free mode, center diff free mode) and the non-differential mode (locked mode, diff locked mode, center diff locked mode) of the center diff 50. For example, when the center diff lock switch 108 is operated to turn on and then maintained in a pushed state, the diff lock operation signal DL_{ON} that indicates that the center diff lock switch 108 is turned on is output, and then the electronic control unit 130 executes engagement control over the diff lock device 54 to thereby change the center diff 50 into the locked mode. On the other hand, when the center diff lock switch 108 is operated to turn off and then released from the pushed state, or when the center diff lock switch 108 is not operated to turn on from the beginning, the diff lock operation signal DL_{ON} that indicates that the center diff lock switch 108 is turned on is not output, and then the electronic control unit 130 executes release control over the diff lock device 54 to thereby change the center diff 50 into the free mode. Note that the center diff lock switch 108 is not limited to the above push button type; instead, the center diff lock switch 108 may be, for example, a slide type, a seesaw type, a dial type, or the like.

Thus, in the vehicle 10 according to the present embodiment, the speed shift dial switch 112 and the center diff lock switch 108 are operated to be able to select a travel mode appropriate for a road surface condition from among four travel modes, that is, a center diff free mode (H4F) at the high gear H in the four-wheel drive mode, a center diff locked mode (H4L) at the high gear H in the four-wheel drive mode (H4L), a center diff free mode (L4F) at the low gear L in the four-wheel drive mode and a center diff locked mode (L4L) at the low gear L in the four-wheel drive mode.

In addition, the diff lock indicator lamp 122 is a lamp that is, for example, provided on a known meter 124 and is used to clearly indicate the center diff locked mode to the user. For example, when the diff lock signal S_{LOCK} that indicates the center diff locked mode is output, the electronic control unit 130 causes the diff lock indicator lamp 122 to light up. In addition, the diff lock indicator lamp 122 also functions as a warning lamp that prompts the user to pay attention to the fact that the center diff 50 is set in the locked mode. For example, when the diff lock indicator lamp 122 is caused to function as a warning lamp, the diff lock indicator lamp 122 may be caused to blink.

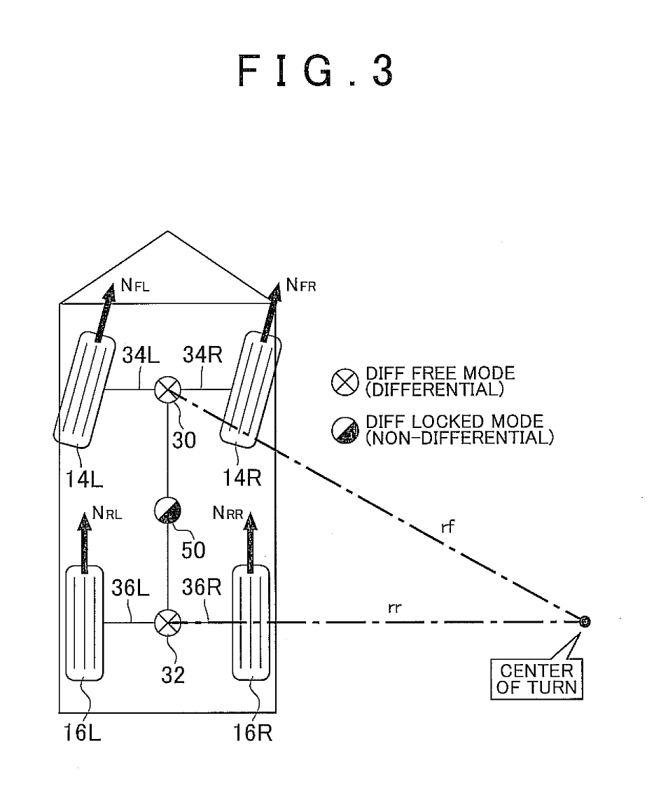

Incidentally, when the vehicle 10 turns a corner, there occurs a difference in rotation between the front wheels and the rear wheels due to a difference in turning radius between the front and rear wheels. At this time, when the vehicle 10 is cornering in the center diff locked mode, a twist accumulates somewhere in the drive train (for example, power transmission path from the engine 12 to the wheels), and then a twisting torque due to the accumulated twist occurs (hereinafter, the twisting torque is termed a generated twisting torque Th). For example, when the vehicle 10 according to the present embodiment turns a corner, as shown in FIG. 3, a front wheel turning radius rf is longer than a rear wheel turning radius rr, so the average wheel speed N_{F} of the front wheels 14 (front wheel speed) (=(N_{FR}+N_{FL})/2) is higher than the average wheel speed N_{R} of the rear wheels 16 (rear wheel speed) (=(N_{RR}+N_{RL})/2). Therefore, when the center diff 50 is set in the diff locked mode, a negative torque (decelerating torque) that drives the front wheels 14 for rotation acts from a travelling road although a driving torque is generated from the engine 12. For example, the front DSs 34 that constitute part of the drive train are twisted in a vehicle travel rotation direction by the front wheels 14, and then the twisting torque that serves as a decelerating torque is added to the front DSs 34 (hereinafter, a twisting torque that directly acts on the front DSs 34 is termed a DS twisting torque Th_{DS}). The above generated twisting torque Th continuously increases as far as the center diff 50 is set in the diff locked mode until at least one of the wheels slips. A tractive torque at which at least one of the wheels starts to slip is relatively large, and the durability of portions (for example, drive train components, such as the front DS 34) that constitute the drive train may possibly deteriorate.

Then, in the present embodiment, in order to improve the durability of the drive train components, when the drive train is placed in a twisted state where a twisting torque resulting from a twist accumulated in the drive train is larger than or equal to a predetermined torque while the vehicle 10 is cornering in a state where the center diff 50 is set in the diff locked mode, braking force is applied to the front wheels 14 by the wheel brake device 96. That is, when the generated twisting torque Th is larger than or equal to the predetermined torque during cornering in the center diff locked mode, not the generated twisting torque Th itself is reduced but part of the generated twisting torque Th is cancelled by the brake torque T_{B} applied to the front wheels 14 to thereby reduce the twisting torque Th that substantially acts on the drive train components. In addition, the brake torque T_{B} is applied to only the front wheels 14 so as to cancel part of the generated twisting torque Th, so the decelerating torque of the vehicle 10 overall is not increased by the brake torque T_{B}. Here, joints adjacent to the front wheels 14 of the front DSs 34 are turned at a large angle while the vehicle 10 is cornering, and the durability of the front DSs 34 may considerably deteriorate as the angle increases as compared with when the vehicle 10 is travelling straight ahead where the joints are substantially not turned. Thus, in the present embodiment, the front DSs 34 are focused on as controlled objects for improving the durability of the drive train components. Therefore, for the sake of convenience, it is assumed that all the generated twisting torque Th acts on the front DSs 34 when control for improving the durability of the drive train components is not executed. Thus, in the present embodiment, when the drive train is placed in the twisted state where the DS twisting torque Th_{DS} (generated twisting torque Th) is larger than or equal to the predetermined torque during cornering in the center diff locked mode, a brake torque T_{B} is applied to the front wheels 14 to cancel part of the generated twisting torque Th to thereby reduce the DS twisting torque Th_{DS} that substantially acts on the front DSs 34. Note that the predetermined torque is an allowable value of the twisting torque Th, which is empirically obtained in advance for suppressing deterioration of the durability of the drive train components. For example, in the front DSs 34, the above predetermined torque is a DS allowable torque Ty that is an allowable value of the DS twisting torque Th_{DS} empirically obtained and set for suppressing deterioration of the durability of the front DSs 34.

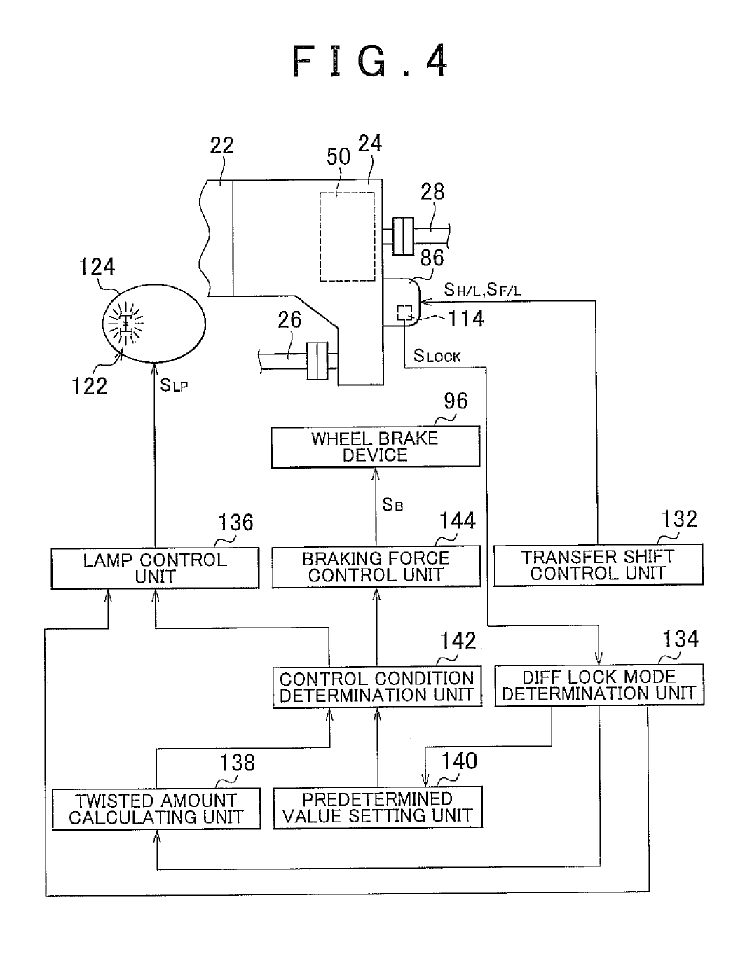

Specifically, FIG. 4 is a functional block diagram that illustrates a relevant portion of control functions implemented by the electronic control unit 130. In FIG. 4, a transfer shift control unit 132, for example, controls a shift of the transfer 24 on the basis of the signal that indicates the operating position P_{DIAL} of the speed shift dial switch 112 and the diff lock operation signal DL_{ON} from the center diff lock switch 108. Specifically, when the signal that indicates the operating position P_{DIAL} is a signal that indicates the High position, the transfer shift control unit 132 outputs, to the shift actuator 86, the high/low shift control command signal S_{H/L} for shifting the gear of the auxiliary transmission 44 into the high gear H to actuate the dog clutch device 52 via the first shift fork shaft 88 to thereby shift the gear of the auxiliary transmission 44 into the high gear H. On the other hand, when the signal that indicates the operating position P_{DIAL} is a signal that indicates the Low position, the transfer shift control unit 132 outputs, to the shift actuator 86, the high/low shift control command signal S_{H/L}, for shifting the gear of the auxiliary transmission 44 into the low gear L to actuate the dog clutch device 52 via the first shift fork shaft 88 to thereby shift the gear of the auxiliary transmission 44 into the low gear L. In addition, when the electronic control unit 130 has received the diff lock operation signal DL_{ON}, the transfer shift control unit 132 outputs, to the shift actuator 86, the center diff mode change control command signal S_{F/L} for changing the center diff 50 into the locked mode to actuate the diff lock device 54 via the second shift fork shaft 92 to thereby change the center diff 50 into the locked mode. On the other hand, when the electronic control unit 130 has not received the diff lock operation signal DL_{ON}, the transfer shift control unit 132 outputs, to the shift actuator 86, the center diff mode change control command signal S_{F/L} for changing the center diff 50 into the free mode to actuate the diff lock device 54 via the second shift fork shaft 92 to thereby change the center diff 50 into the free mode.

A diff lock mode determination unit 134, for example, determines whether the center diff 50 is set in the locked mode on the basis of whether the diff lock signal S_{LOCK} is output from the diff lock detecting switch 114. In other words, the diff lock mode determination unit 134 determines whether the travel mode in the transfer 24 is set in any one of “H4L” and “L4L”. Specifically, when the electronic control unit 130 has received the diff lock signal S_{LOCK}, the diff lock mode determination unit 134 determines that the center diff 50 is set in the locked mode; whereas, when the electronic control unit 130 has not received the diff lock signal S_{LOCK}, the diff lock mode determination unit 134 determines that the center diff 50 is set in the free mode.

For example, when the diff lock mode determination unit 134 determines that the center diff 50 is set in the locked mode, a lamp control unit 136 outputs the lamp control command signal S_{LP} for lighting up the diff lock indicator lamp 122 to the meter 124 to thereby light up the diff lock indicator lamp 122.

Here, a twist of the front DSs 34, which is a source of the DS twisting torque Th_{DS} during cornering in the center diff locked mode, accumulates in the drive train (front DSs 34) because of a front and rear differential speed that is a difference in rotational between the front wheel speed N_{F} (=(N_{FR}+N_{FL})/2) and the rear wheel speed N_{R} (=(N_{RR}+N_{RL})/2), that is, a front and rear wheel rotational speed difference ΔN_{FR} (=N_{F}−N_{R}) between the front wheels 14 and the rear wheels 16. The twist of the front DSs 34 is in a one-to-one proportion to the DS twisting torque Th_{DS}, and the DS twisting torque Th_{DS} increases as the twist of the front DSs 34 increases during cornering in the center diff locked mode. Therefore, in the present embodiment, not the DS twisting torque Th_{DS} is directly used but a twisted state of the drive train where the DS twisting torque Th_{DS} is larger than or equal to the DS allowable torque Ty is detected on the basis of the front and rear wheel rotational speed difference ΔN_{FR}, for example, on the basis of a DS twisted amount (front and rear differential amount) θdf that is the amount of twist (twisted angle) of the front DSs 34, calculated from the front and rear wheel rotational speed difference ΔN_{FR} during cornering.

More specifically, for example, when the diff lock mode determination unit 134 determines that the center diff 50 is set in the locked mode, a twisted amount calculating unit 138 calculates a DS twisted amount θdf on the basis of an integrated value of the front and rear wheel rotational speed difference ΔN_{FR} during cornering. Specifically, the twisted amount calculating unit 138 calculates a DS twisted amount θdf on the basis of the front and rear wheel rotational speed difference ΔN_{FR} using the following mathematical expression (1). Note that r in the following mathematical expression (1) is a tire radius.

Δdf=∫(ΔN_{FR})dt/(2πr) (1)

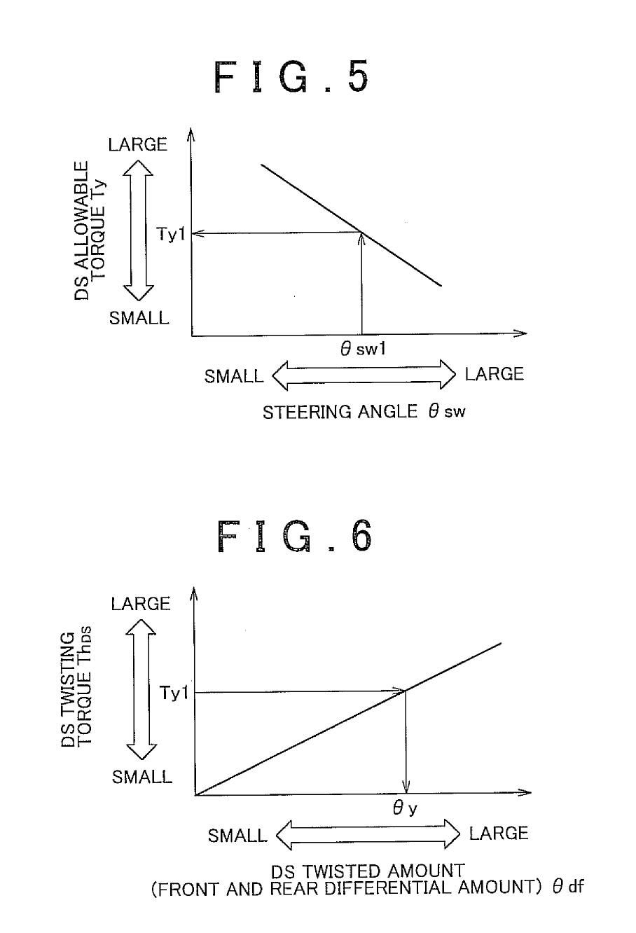

A predetermined value setting unit 140, for example, sets a DS allowable torque Ty (for example, Ty1) on the basis of an actual steering angle θ_{SW} (for example, θ_{SW}1) from a correlation (allowable torque map), for example, shown in FIG. 5, which is empirically obtained and set in advance so that the DS allowable torque Ty, which is the predetermined torque, reduces as the steering angle θ_{SW} of the steering wheel 120 during cornering increases. In addition, the predetermined value setting unit 140, for example, sets a DS allowable twisted amount θy that is a predetermined value of the DS twisted amount θdf, which corresponds to a predetermined amount of twist, that is, an allowable value of the amount of twist, on the basis of the set DS allowable torque Ty (for example, Ty1) from a correlation (twisting torque map), for example, shown in FIG. 6, which is empirically obtained and set in advance so that the DS twisting torque Th_{DS} increases as the DS twisted amount θdf increases.

A control condition determination unit 142, for example, determines whether a braking control condition for executing control for applying braking force to the front wheels 14 by the wheel brake device 96 is satisfied. Specifically, the control condition determination unit 142 determines whether the DS twisted amount θdf calculated by the twisted amount calculating unit 138 is larger than or equal to the DS allowable twisted amount θy set by the predetermined value setting unit 140. That is, the control condition determination unit 142 detects the twisted state of the drive train where the DS twisting torque Th_{DS} is larger than or equal to the DS allowable torque Ty because the DS twisted amount θdf is larger than or equal to the DS allowable twisted amount θy. Note that, in the present embodiment, when the drive train is placed in the twisted state during cornering in the center diff locked mode, but when braking force is originally applied to the front wheels 14 by the user through the wheel brake device 96, the above control is not executed because the control is intended to apply braking force to the front wheels 14 by the wheel brake device 96. Then, the control condition determination unit 142 further determines whether the wheel brake device 96 is not actuated through user's operation, that is, braking is not operated, as a braking control condition on the basis of whether the brake operation signal B_{ON} is output.

For example, when the control condition determination unit 142 determines that the braking control condition is satisfied, a braking force control unit 144 applies a brake torque T_{B} to the front wheels 14 so as to cancel the amount of twisting torque corresponding to part of the DS twisting torque Th_{DS}, that is, the amount of twisting torque corresponding to a DS twisted amount difference Δθdf (=θdf−θy) that is a difference between the DS twisted amount θdf and the DS allowable twisted amount θy. That is, within the generated DS twisting torque Th_{DS}, the twisting torque that substantially acts on the front DSs 34 is reduced to at or below the DS allowable torque Ty, and the remaining amount of twisting torque (=Th_{DS}−Ty) is cancelled by the brake torque T_{B} applied to the front wheels 14 (front brake torque T_{BF}).

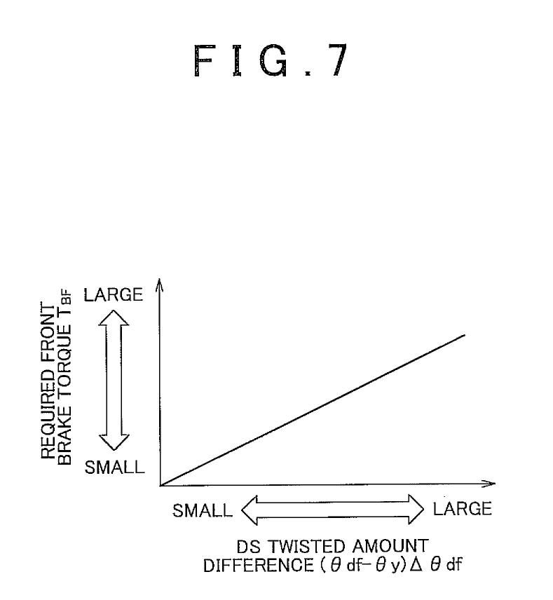

Specifically, when the control condition determination unit 142 determines that the DS twisted amount θdf is larger than or equal to the DS allowable twisted amount θy and braking is not operated, the braking force control unit 144 sets a required front brake torque T_{BF} on the basis of a calculated actual DS twisted amount difference Δθdf from a correlation (required brake torque map), for example, shown in FIG. 7, and then outputs, to the wheel brake device 96, the wheel brake operation signal S_{B} for applying the brake torque T_{B} to the front wheels 14 so as to be able to obtain the required front brake torque T_{BF}. The correlation shown in FIG. 7 is empirically obtained and set in advance so that the required front brake torque T_{BF} that is a front brake torque T_{BF} required for cancelling the twisting torque corresponding to the DS twisted amount difference Δθdf increases as the DS twisted amount difference Δθdf increases.

In addition, even when the braking control (front braking control) is executed, the generated DS twisting torque Th_{DS} itself is not reduced, and, as far as cornering in the center diff locked mode is continued, the DS twisted amount θdf, that is, the generated DS twisting torque Th_{DS}, continuously increases until at least any one of the wheels slips. Then, for example, in terms of prompting the user to release the center diff locked mode and changes into the center diff free mode, it is applicable that the diff lock indicator lamp 122, which lights up in the center diff locked mode, is caused to blink to thereby cause the diff lock indicator lamp 122 to operate as a warning lamp. Specifically, for example, when the control condition determination unit 142 determines that the braking control condition is satisfied, the lamp control unit 136 outputs the lamp control command signal S_{LP} for blinking the diff lock indicator lamp 122 to the meter 124 to thereby blink the diff lock indicator lamp 122 that has lit up.

On the other hand, for example, when the control condition determination unit 142 determines that the braking control condition is not satisfied during the front braking control, the braking force control unit 144 cancels the front braking control. In addition, for example, when the control condition determination unit 142 determines that the braking control condition is not satisfied while the diff lock indicator lamp 122 is blinking, that is, during warning lamp operation, the lamp control unit 136 cancels the warning lamp operation.

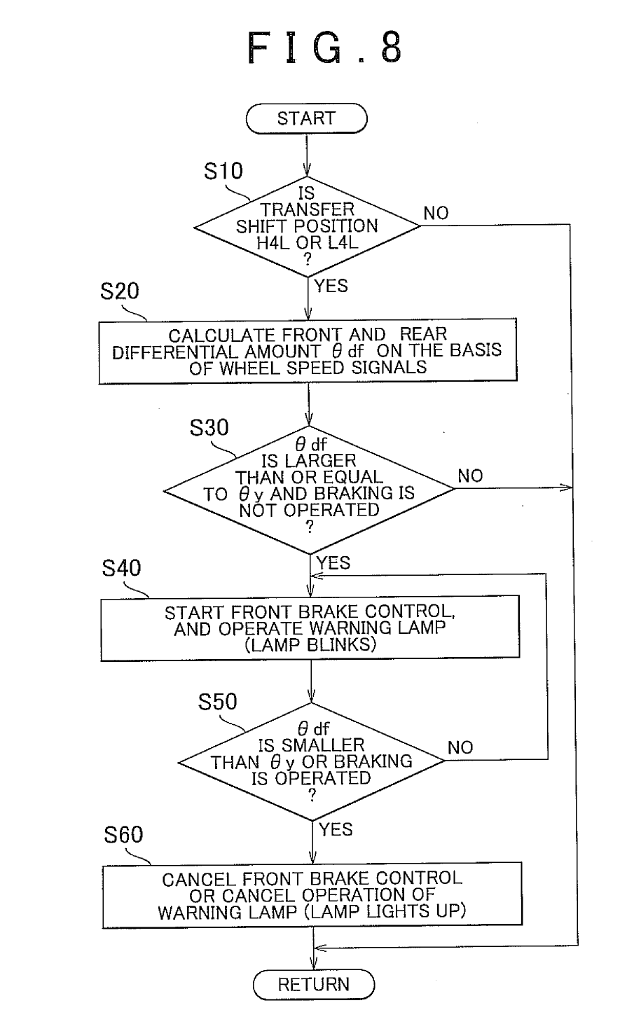

FIG. 8 is a flowchart that illustrates a relevant portion of control operations of the electronic control unit 130, that is, control operations for improving the durability of the drive train components (for example, the front DSs 34) by reducing a twisting torque (DS twisting torque Th_{DS}) substantially applied to the drive train (for example, the front DSs 34). The flowchart is repeatedly executed in an extremely short cycle time of, for example, about several milliseconds to several tens of milliseconds.

In FIG. 8, first, in step (hereinafter, step is omitted) S10 corresponding to the diff lock mode determination unit 134, for example, it is determined whether the center diff 50 is set in the locked mode on the basis of whether the diff lock signal S_{LOCK} is output. Instead, it may be determined whether the travel mode in the transfer 24 is set in any one of “H4L” and “L4L”. When the determination of S10 is negative, the routine ends; whereas, when the determination of S10 is affirmative, in S20 corresponding to the twisted amount calculating unit 138 and the predetermined value setting unit 140, for example, a DS twisted amount θdf is calculated on the basis of a front and rear wheel rotational speed difference ΔN_{FR} (=(N_{FR}+N_{FL})/2−(N_{RR}+N_{RL})/2) using the mathematical expression (1). In addition, for example, the DS allowable torque Ty is set on the basis of an actual steering angle θ_{SW} from the allowable torque map as shown in FIG. 5. Specifically, when the actual steering angle θ_{SW} is a steering angle θ_{SW}1, a DS allowable torque Ty1 is set as the DS allowable torque Ty. In addition, for example, a DS allowable twisted amount θy is set on the basis of the set DS allowable torque Ty (for example, Ty1) from the twisting torque map as shown in FIG. 6. Subsequently, in S30 corresponding to the control condition determination unit 142, for example, it is determined whether the DS twisted amount θdf calculated in S20 is larger than or equal to the DS allowable twisted amount θy set in S20 and braking is not operated. When the determination of S30 is negative, the routine ends; whereas, when the determination of S30 is affirmative, in S40 corresponding to the braking force control unit 144 and the lamp control unit 136, for example, a required front brake torque T_{BF} is set on the basis of an actual DS twisted amount difference Δθdf (=θdf−θy) from the required brake torque map as shown in FIG. 7. Then, the wheel brake operation signal S_{B} for applying a front brake torque T_{BF} to the front wheels 14 is output to the wheel brake device 96 so as to obtain the required front brake torque T_{BF} to thereby start front brake control. In addition, the lamp control command signal S_{LP} for blinking the diff lock indicator lamp 122 is output to the meter 124 to blink the diff lock indicator lamp 122 that has lit up to thereby execute warning lamp operation. Subsequently, in S50 corresponding to the control condition determination unit 142, for example, it is determined whether the DS twisted amount θdf is smaller than the DS allowable twisted amount θy or whether braking is operated. When the determination of S50 is negative, the process returns to S40; whereas, when the determination of S50 is affirmative, in S60 corresponding to the braking force control unit 144 and the lamp control unit 136, for example, front brake control executed in S40 is cancelled, and warning lamp operation executed similarly in S40 is cancelled, that is, the blinking diff lock indicator lamp 122 is caused to light up.

As described above, according to the present embodiment, when the twisted state of the drive train is generated where the generated twisting torque Th (DS twisting torque Th_{DS}) resulting from the twist accumulated in the drive train is larger than or equal to the predetermined torque (DS allowable torque Ty) during cornering in the center diff locked mode, a brake torque T_{B} is applied to the front wheels 14 by the wheel brake device 96. Therefore, for example, part of the DS twisting torque Th_{DS} applied to the front wheels 14 may be cancelled by the brake torque T_{B} applied by the wheel brake device 96, so the DS twisting torque Th_{DS} that is actually applied to the drive train (front DSs 34) is reduced. That is, part of the generated twisting torque Th (DS twisting torque Th_{Ds}) is cancelled by the front brake torque T_{BF}, so the DS twisting torque Th_{Ds} that acts on the drive train components (front DSs 34) is reduced. Thus, the durability of the drive train components is improved. Therefore, for example, it is not necessary to increase the size of the drive train components in order to ensure the durability of the drive train components, and it is possible to reduce the size and weight of the drive train components.

In addition, according to the present embodiment, the predetermined torque (DS allowable torque Ty) is an allowable value of the twisting torque (DS twisting torque Th_{Ds}) for suppressing deterioration of the durability of the drive train components (front DSs 34), and is set on the basis of an actual steering angle θ_{SW} from a predetermined correlation (allowable torque map), for example, shown in FIG. 5, which is set in advance so that the predetermined torque (DS allowable torque Ty) is reduced as the steering angle θ_{SW} of the steering wheel 120 during cornering increases. Therefore, for example, in contrast to that the allowable torque DS (allowable torque Ty) of the drive train components (front DSs 34) against the twisting torque (DS twisting torque Th_{Ds}) reduces as the steering angle θ_{SW} increases, the predetermined torque (DS allowable torque Ty) is set from the predetermined correlation, so the twisting torque that acts on the drive train components is appropriately reduced to improve the durability of the drive train components. In addition, a front brake torque T_{BF} is applied by the wheel brake device 96 in accordance with the steering angle θ_{SW}, so turning performance (travelling performance) is appropriately ensured. That is, for example, part of a decelerating torque that acts on the front wheels 14 is appropriately cancelled by the front brake torque T_{BF}, so a decelerating torque of the vehicle overall is not increased by the front brake torque T_{BF}, and travelling performance is appropriately ensured.

In addition, according to the present embodiment, the twist (twist of the front DSs 34) accumulates in the drive train (front DSs 34) depending on the front and rear wheel rotational speed difference ΔN_{FR} (=N_{F}−N_{R}) between the front wheels 14 and the rear wheels 16, and the twisted state of the drive train (the twisted state of the drive train where the DS twisting torque Th_{Ds} is larger than or equal to the DS allowable torque Ty) is detected on the basis of the front and rear wheel rotational speed difference ΔN_{FR}, so, for example, the twisted state of the drive train where the twisting torque is larger than or equal to the predetermined torque is appropriately detected.

In addition, according to the present embodiment, a twisted amount of the drive train (DS twisted amount θdf) is calculated on the basis of an integrated value of the front and rear wheel rotational speed difference ΔN_{FR} during cornering, a predetermined amount of twist (DS allowable twisted amount θy) is set on the basis of a predetermined torque (DS allowable torque Ty) from a predetermined correlation (twisting torque map), for example, shown in FIG. 6, which is set in advance so that the twisting torque (DS twisting torque Th_{Ds}) increases as the amount of twist increases, and then the twisted state of the drive train is detected when the amount of twist is larger than or equal to the predetermined amount of twist. Therefore, for example, the twisted state of the drive train where the twisting torque is larger than or equal to the predetermined torque is reliably detected.

In addition, according to the present embodiment, a brake torque T_{B} is applied to the front wheels 14 so as to cancel the amount of twisting torque corresponding to part of the generated twisting torque Th (DS twisting torque Th_{Ds}), that is, the amount of twisting torque corresponding to a difference (DS twisted amount difference Δθdf (=θdf−θy)) between the amount of twist of the drive train (DS twisted amount θdf) and the predetermined amount of twist (DS allowable twisted amount θy). Therefore, for example, part of the generated twisting torque Th may be appropriately cancelled by the front brake torque T_{BF} applied by the wheel brake device 96 so that the twisting torque (DS twisting torque Th_{Ds}) that substantially acts on the drive train components (front DSs 34) is not larger than or equal to the predetermined torque (DS allowable torque Ty).

The embodiment of the invention is described in detail above with reference to the accompanying drawings; however, the aspect of the invention may also be applied to other embodiments.

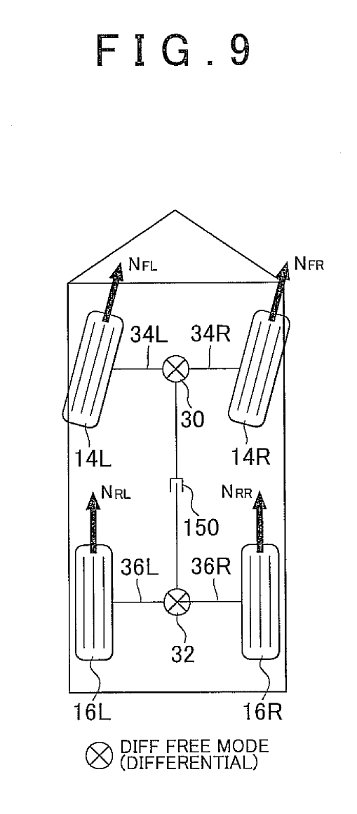

For example, in the above described embodiment, the aspect of the invention is applied to the full-time four-wheel drive vehicle 10 that includes the transfer 24 having the center diff 50 that may be changed by the diff lock device 54 between the free mode and the locked mode; however, the aspect of the invention is not limited to this configuration. For example, the aspect of the invention may also be applied to a so-called part-time four-wheel drive vehicle in which, as shown in FIG. 9, instead of the center diff 50, a power interrupting device (clutch) 150 that is able to selectively interrupt a power transmission path between the first output shaft 46 and the second output shaft 48 is provided, and, the vehicle travels in a two-wheel drive mode when the power interrupting device 150 is set in a free mode (released state); whereas, when the power interrupting device 150 is set in a locked mode (engaged state), the power transmission path adjacent to the front wheels 14 and the power transmission path adjacent to the rear wheels 16 are directly coupled to each other to enter a direct-coupling four-wheel drive mode and then the vehicle travels in a drive mode similar to the center diff locked mode of the vehicle 10. In short, the aspect of the invention may be applied to any four-wheel drive vehicles that are able to travel in the non-differential mode in which differential rotation between the front wheels 14 and the rear wheels 16 is limited.

In addition, in the above described embodiment, the front DSs 34 are illustrated as the drive train or the drive train components; however, the drive train or the drive train components are not limited to the front DSs 34. For example, the aspect of the invention may also be applied to the front propeller shaft, or the like. In short, the aspect of the invention may be applied to any drive trains (drive train components) in which a twist accumulates during cornering in the center diff locked mode.

In addition, in the above described embodiment, the predetermined torque (DS allowable torque Ty) that is set so as to be reduced as the steering angle θ_{SW} of the steering wheel 120 during cornering increases is used; however, the predetermined torque is not limited to this configuration. For example, a constant (uniform) predetermined torque (DS allowable torque Ty) that is empirically obtained and stored in advance so as to correspond to a somewhat large steering angle θ_{SW} may be used. By so doing as well, a certain advantageous effect according to the aspect of the invention may be obtained. In addition, the steering angle θ_{SW} of the steering wheel 120 is used to set the predetermined torque; however, the aspect of the invention is not limited to this configuration. For example, a steered angle of the front wheels 14, or the like, may be used instead.

Note that the above described embodiment is only illustrative; the aspect of the invention may be implemented in forms with various modifications or improvements based on the knowledge of a person skilled in the art.

What is claimed is:

1. A control device for a four-wheel drive vehicle that is able to travel in a non-differential mode in which differential rotation between front wheels and rear wheels is limited, the control device comprising:
a control condition determination unit that determines whether a drive train is placed in a twisted state where a twisting torque resulting from a twist accumulated in the drive train is larger than or equal to a predetermined torque while the vehicle is cornering in the non-differential mode; and
a braking force control unit that applies braking force to the front wheels by a wheel brake device when it is determined that the drive train is placed in the twisted state.

2. The control device according to claim 1, wherein
the predetermined torque is reduced as a steering angle during the cornering increases.

3. The control device according to claim 2, wherein
the predetermined torque is an allowable value of the twisting torque for suppressing deterioration of durability of drive train components, and is set on the basis of an actual steering angle from a predetermined correlation.

4. The control device according to claim 1, wherein
the twist is accumulated in the drive train because of a front and rear wheel rotational speed difference between the front wheels and the rear wheels, and it is determined whether the drive train is placed in the twisted state on the basis of the front and rear wheel rotational speed difference.

5. The control device according to claim 4, wherein
an amount of twist accumulated in the drive train is calculated on the basis of an integrated value of the front and rear wheel rotational speed difference during the cornering, a predetermined amount of twist is set on the basis of the predetermined torque from a predetermined correlation in which the twisting torque increases as the amount of twist increases, and, when the amount of twist is larger than or equal to the predetermined amount of twist, it is determined that the drive train is placed in the twisted state.

6. The control device according to claim 5, wherein
in the predetermined correlation, the amount of twist is in a proportion to the twisting torque.

7. The control device according to claim 1, wherein
the braking force control unit applies braking force to the front wheels so as to cancel a difference between the twisting torque and the predetermined torque when it is determined that the drive train is placed in the twisted state.

8. A control method for a four-wheel drive vehicle that is able to travel in a non-differential mode in which differential rotation between front wheels and rear wheels is limited, the control method comprising:
determining whether a drive train is placed in a twisted state where a twisting torque resulting from a twist accumulated in the drive train is larger than or equal to a predetermined torque while the vehicle is cornering in the non-differential mode; and
applying braking force to the front wheels by a wheel brake device when it is determined that the drive train is placed in the twisted state.

9. The control method according to claim 8, wherein
the predetermined torque is reduced as a steering angle during the cornering increases.

10. The control method according to claim 9, wherein
the predetermined torque is an allowable value of the twisting torque for suppressing deterioration of durability of drive train components, and is set on the basis of an actual steering angle from a predetermined correlation.

11. The control method according to claim 8, wherein
the twist is accumulated in the drive train because of a front and rear wheel rotational speed difference between the front wheels and the rear wheels, and it is determined whether the drive train is placed in the twisted state on the basis of the front and rear wheel rotational speed difference.

12. The control method according to claim 11, wherein
an amount of twist accumulated in the drive train is calculated on the basis of an integrated value of the front and rear wheel rotational speed difference during the cornering, a predetermined amount of twist is set on the basis of the predetermined torque from a predetermined correlation in which the twisting torque increases as the amount of twist increases, and, when the amount of twist is larger than or equal to the predetermined amount of twist, it is determined that the drive train is placed in the twisted state.

13. The control method according to claim 12, wherein
in the predetermined correlation, the amount of twist is in a proportion to the twisting torque.

14. The control method according to claim 8, wherein
braking force is applied to the front wheels so as to cancel a difference between the twisting torque and the predetermined torque when it is determined that the drive train is placed in the twisted state.
